(19) United States
(12) Patent Application Publication
(10) Pub. No.: US 2025/0162461 A1
(43) Pub. Date: May 22, 2025

(54) Method and Device for Controlling an Inverter of a Vehicle, and Vehicle

(71) Applicant: Bayerische Motoren Werke Aktiengesellschaft, Muenchen (DE)

(72) Inventor: Said EL-BARBARI, Freising (DE)

(21) Appl. No.: 18/839,063

(22) PCT Filed: Mar. 13, 2023
(86) PCT No.: PCT/EP2023/056295

§ 371 Date: Aug. 16, 2024

(30) Foreign Application Priority Data
Mar. 21, 2022 (DE) 10 2022 106 506.5

(51) Int. Cl. B60L 58/27; B60L 1/02; H01M 10/615; H01M 10/625

(52) U.S. Cl. CPC B60L 58/27; B60L 1/02; H01M 10/615; H01M 10/625; B60L 2210/40; B60L 2240/36; B60L 2240/525; B60L 2240/545; H01M 2220/20

(57) ABSTRACT

A method and a device for controlling an inverter of a vehicle, and such a vehicle are disclosed. The method includes: ascertaining information concerning a heating requirement of a battery of the vehicle; controlling the inverter in a first mode in which current provided by the battery flows through an electric motor of the vehicle; and controlling the inverter in a second mode which represents freewheeling of the inverter, in which freewheeling current flowing through inverse diodes of semiconductor switches of the inverter leads to the heating of the battery. A repeated switchover is made between the first mode and the second mode. An average current flowing through the electric motor corresponds to a DC current which does not cause any torque in the electric motor. Respective switchover points in time between the first mode and the second mode are defined according to the heating requirement of the battery.

### BACKGROUND AND SUMMARY

The present invention relates to a method for controlling an inverter of a vehicle, and to such a vehicle.

Drivetrains of electrically driven vehicles are known from the prior art, in which waste heat of IGBT-based inverters and/or waste heat of electric motors due to switching and conduction losses is/are used for heating (also called preconditioning) of a drive battery of these vehicles. For this purpose, the inverters and/or electric motors are thermally coupled to the battery, for example, via a cooling circuit, so that their waste heat can be transferred to the battery.

Such preconditioning of the battery is relevant in particular if the battery is to be subjected to a charging process while the battery has a low temperature. This can result, among other things, in increased charging times, which are generally disadvantageous for users of the vehicles.

Furthermore, inverters are known from the prior art which use SiC-MOSFETs or semiconductors differing therefrom having broad bandgap, since they have lower conduction and switching losses in relation to IGBT-based inverters, in particular in a part load range, and thus enable, for example, a longer range of electrically driven vehicles. Due to the lower conduction and switching losses, however, a sufficiently high heating contribution to the preconditioning of a battery cannot be generated on the basis of inverters based on SiC-MOSFETs.

German patent document DE 102012223054 A1 describes a method for the thermal management of an electric vehicle. A control unit is configured to regulate the temperature of a traction battery to within an operating temperature range when the vehicle is in operation. The temperature of the battery is regulated to within a charging temperature range when the battery is connected to the charger and the power source and the outside temperature is outside an ambient temperature range. For this purpose, the battery is connected in one embodiment to a thermal circuit.

It is an object of the present invention to achieve sufficient preconditioning for a battery on the basis of waste heat of an inverter having low switching and conduction losses.

The object identified above is achieved by the features of the independent claims. The dependent claims contain preferred refinements of the invention.

According to a first aspect of the present invention, a method for controlling an inverter of a vehicle is proposed. In a first step of the method according to the invention, information is ascertained about a heating requirement of a battery electrically and thermally coupled with the inverter of the vehicle, wherein the battery is preferably a drive battery for an electrically drivable vehicle. Such a heating requirement of the battery is present, for example, if the battery is to be subjected to a charging process when prevailing ambient temperatures are low, since a low battery temperature (for example below 0°0 C.) generally results in an increased charging time. The heating requirement for the battery is ascertained, for example, on the basis of one or more temperature sensors which are thermally coupled with the battery directly or indirectly (for example, temperature sensors which are arranged on a cooling device and/or in a coolant circuit for the battery, etc.). Alternatively or additionally, it is also conceivable to estimate a temperature of the battery on the basis of temperature sensors which are not directly or indirectly thermally coupled with the battery and are, for example, temperature sensors for detecting an ambient temperature of the vehicle. Furthermore, alternatively or additionally, it is also possible to estimate a temperature of the battery on the basis of weather data which are received in the vehicle. A difference between the ascertained temperature and a predefined target temperature of the battery accordingly represents the heating requirement of the battery. It is to be noted that the target temperature can have different values depending on a planned usage of the battery (for example, driving operation or charging operation, etc.). The heating requirement of the battery is ascertained, for example, by means of an evaluation unit according to the invention, which is advantageously configured to carry out these and following method steps, for example, on the basis of a computer program. To ascertain the heating requirement of the battery, such an evaluation unit is, for example, directly or indirectly connected in terms of information technology to the temperature sensor or the temperature sensors which detects or detect the temperature of the battery. In a second step of the method according to the invention, the evaluation unit controls the inverter in a first mode, in which a current provided by the battery flows through an electric motor of the vehicle (preferably a drive motor of the vehicle) electrically coupled with an AC terminal (i.e., an alternating current terminal which here and hereinafter can also represent a multiphase AC terminal) of the inverter. For this purpose, semiconductor switches of the inverter having respective inverse diodes (also called “body” diodes) are advantageously controlled in correspondence with an angular position of a rotor of the electric motor, so that a corresponding current flow through the electric motor is achieved. Methods known from the prior art for ascertaining the angular position of the rotor and for controlling the semiconductor switches of the inverter in accordance with the respective angular position can be used for this purpose. In a third step of the method according to the invention, the inverter is controlled by the evaluation unit in a second mode which represents a freewheel of the inverter in which a freewheel current flowing through the inverse diodes of specific semiconductor switches of the inverter results in heating of the battery thermally coupled with the inverter. The method according to the invention provides for changing recurrently between the first mode and the second mode at least until the heating requirement of the battery is covered. Furthermore, it is provided that the control of the inverter viewed over time (i.e., over multiple successive changes between the first mode and the second mode) takes place in such a way that an average current flowing through the electric motor corresponds to a direct current which does not induce a torque in the electric motor. In addition, it is provided that respective switching times for the recurring change between the first mode and the second mode are determined in dependence on the heating requirement of the battery. The method according to the invention offers the advantage that in spite of the use of semiconductors, which have a lower conduction and/or switching loss in particular in part load ranges or specific load ranges, a heating contribution sufficient for preconditioning of a battery of a vehicle is enabled by the inverter controlled according to the invention in that the heating is generated in particular via a current flow via inverse diodes of these semiconductor switches.

In one advantageous embodiment of the present invention, the semiconductor switches of the inverter are SiC-MOSFETs and/or GaN-MOSFETs and/or Si-MOSFETs. In addition, it is possible that the inverter and the electric motor are each designed as single-phase or multiphase and particularly advantageously three-phase and/or that the electric motor is a separately excited synchronous machine.

In addition, the battery is particularly advantageously thermally coupled with the electric motor so that heating of the electric motor caused by the current flow in the electric motor can additionally be used for heating the battery. Thermal coupling of the electric motor to the battery takes place, for example, via a jointly used cooling circuit and/or via a thermal coupling differing therefrom.

A first heating contribution provided by the inverter and/or a second heating contribution provided by the electric motor for heating the battery are preferably heating contributions which are determined, for example, by a determination of switching frequencies of the recurring change between the first mode and the second mode. By means of a higher switching frequency, for example, a heating contribution can be generated due to higher switching losses by the semiconductor switches of the inverter. Alternatively or additionally, the respective heating contributions can be achieved by a determination of levels of respective gate voltages of the semiconductors of the inverter. Because the semiconductor switches are operated, for example, with lower turn-on voltages (for example, less than 18 V or less than 15 V, etc.), higher conduction losses can be generated in the semiconductor switches of the inverter, due to which a heating contribution of the inverter to the overall heating can be increased accordingly. Furthermore, alternatively or additionally, it is possible to achieve respective heating contributions by a determination of durations of dead times which are to be observed during a complementary switching of corresponding high-side and low-side semiconductor switches of the inverter in order to prevent short circuits in the inverter. It is to be noted that the respective heating contributions can be predefined heating contributions or heating contributions which can be adapted on the basis of a control and/or a regulation. In this way, it is possible to achieve or maintain an application-specific suitable balance between the heating contribution by the inverter and the heating contribution by the electric motor.

The above-mentioned heating contributions to the heating of the battery of the vehicle are advantageously determined in dependence on a current capacity of the inverter and/or the electric motor. The first heating contribution and the second heating contribution are preferably limited upon reaching the respective current capacities, so that no damage to the inverter and/or the electric motor can occur because of the preconditioning of the battery.

Furthermore, it is possible that those semiconductor switches of the inverter, the inverse diodes of which conduct the freewheel current in the second mode of the inverter, are permanently switched off and in particular are actively switched off during the entire heating phase or only during a part of the heating phase (for example, over multiple changes between the first mode and the second mode) of the battery, for example, by means of a gate voltage of −5 V. Alternatively or additionally, it is possible that those semiconductor switches of the inverter, the inverse diodes of which conduct the freewheel current in the second mode of the inverter are switched, taking into consideration respective required dead times, in a complementary manner to their respective corresponding high-side or low-side semiconductor switches. The latter therefore corresponds to a synchronous rectification, known from the prior art, by the inverter.

In a further advantageous embodiment of the present invention, the dead times required for avoiding short circuits in the complementary switching of corresponding low-side and high-side semiconductor switches are initially determined in dependence on the heating requirement of the battery (for example, at the factory or at the beginning or before the beginning of a charging cycle, etc.) and/or are adapted over time in a suitable manner. The latter enables, for example, by a use of longer dead times at the beginning of a charging process, initially faster heating, which is gradually equalized to a target temperature to be achieved during the heating by a following use of shorter dead times. For this purpose, for example, a control of the dead times on the basis of predefined characteristic curves and/or tables and/or a regulation of the dead times on the basis of a temperature measurement of the battery can be used.

The heating requirement of the battery is advantageously ascertained in dependence on a planned charging process of the battery. For this purpose, for example, a signal of a charging device in the vehicle and/or a charging station electrically coupled with the vehicle is received and used as a trigger to carry out the method according to the invention.

Furthermore, it is also possible to ascertain a planned charging process on the basis of a predefined time of day and/or on the basis of an approach of the vehicle to a charging station and/or on the basis of criteria and/or events deviating therefrom. As already described above, a heating of the battery corresponding to the heating requirement of the battery can take place on the basis of a control and/or a regulation which is preferably executed by means of an above-described evaluation unit.

According to a second aspect of the present invention, a device for controlling an inverter of a vehicle is proposed, wherein the device can be an independent component and/or a component part of the inverter itself. The device has an evaluation unit having a data input and a data output, wherein the evaluation unit can be designed, for example, as an ASIC, FPGA, processor, digital signal processor, microcontroller, or the like. The evaluation unit is configured, in conjunction with the data input, to ascertain information about a heating requirement of a battery of the vehicle that is electrically and thermally coupled with the inverter. In addition, the evaluation unit is configured in conjunction with the data output to control the inverter in a first mode, in which a current provided by the battery flows through an electric motor of the vehicle electrically coupled with an AC terminal of the inverter, to control the inverter in a second mode, which represents a freewheel of the inverter, in which a freewheel current flowing through inverse diodes of semiconductor switches of the inverter results in heating of the battery thermally coupled with the inverter, to change recurrently between the first mode and the second mode at least until the heating requirement of the battery is covered, and to control the inverter in such a way that an average current flowing through the electric motor corresponds to a direct current, which does not induce a torque in the electric motor. Furthermore, the evaluation unit is configured to determine respective switching times for the recurring change between the first mode and the second mode in dependence on the heating requirement of the battery.

According to a third aspect, a vehicle is proposed, which comprises a device according to the second-mentioned aspect of the invention. The vehicle can be, for example, a road vehicle (e.g., motorcycle, passenger vehicle, van, truck) or a rail vehicle or an aircraft/airplane and/or a water vehicle. The features and combinations of features as well as the advantages resulting therefrom correspond to those set forth in conjunction with the first-mentioned and second-mentioned aspects of the invention in such a clear way that reference is made to the above statements to avoid repetitions.

Further details, features, and advantages of the invention result from the following description and the figures. In the figures:

### BRIEF DESCRIPTION OF THE DRAWINGS

FIG. 1 shows a flow chart illustrating steps of an exemplary embodiment of a method according to the invention;

FIG. 2 shows a schematic overview of components of a device according to the invention in conjunction with a vehicle;

FIG. 3a shows an exemplary control of an inverter according to the invention according to a first mode;

FIG. 3b shows an exemplary control of an inverter according to the invention according to a second mode; and

FIG. 4 shows exemplary signal curves of the control of an inverter according to the invention.

### DETAILED DESCRIPTION OF THE DRAWINGS

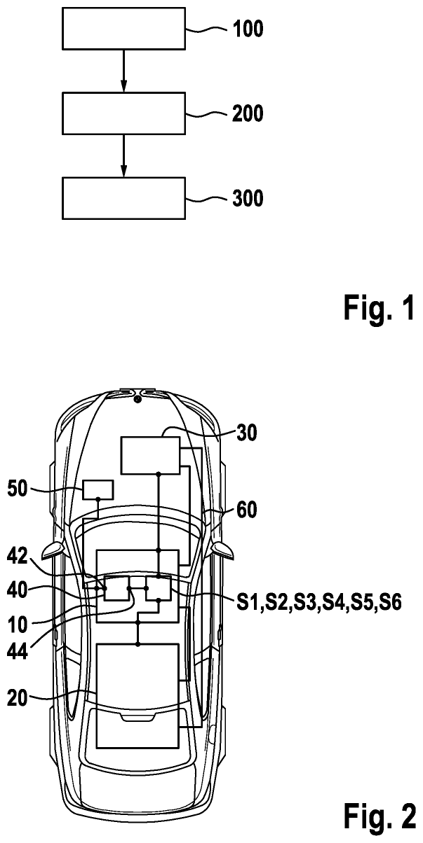

FIG. 1 shows a flow chart illustrating steps of an exemplary embodiment of a method according to the invention. In step 100 of the method according to the invention, by means of an evaluation unit 40, designed as a microcontroller, of an inverter 10 for a vehicle, information about a heating requirement of a battery 20 of the vehicle electrically and thermally coupled with the inverter 10 is ascertained. The ascertainment takes place on the basis of a charge request, received by the evaluation unit 40, for charging the battery 20 and on the basis of temperature information, received by the evaluation unit 40, representing a current temperature of the battery 20. In the case of an existing charge request and a negative deviation of the current temperature of the battery 20 from a predefined target temperature of the battery 20, a level of a heating requirement of the battery 20 is ascertained by the evaluation unit 40. In step 200 of the method according to the invention, the evaluation unit 40 controls SiC-MOSFETs S1, S2, S3, S4, S5, S6 of the inverter 10 in a first mode, in which a current I provided by the battery 20 flows through an electric motor 30 of the vehicle electrically coupled with an AC terminal of the inverter 10. In step 300 of the method according to the invention, the evaluation unit 40 controls the SiC-MOSFETs S1, S2, S3, S4, S5, S6 of the inverter 10 in a second mode, which represents a freewheel of the inverter 10, in which a freewheel current flowing through inverse diodes of the SiC-MOSFETs S1, S2, S3, S4, S5, S6 of the inverter 10 results in heating of the battery 20 thermally coupled with the inverter 10. The control of the respective SiC-MOSFETs S1, S2, S3, S4, S5, S6 takes place in consideration of information about a current angular position of a rotor of the electric motor 30, which is made available in terms of information technology to the evaluation unit 40. Moreover, the control of the SiC-MOSFETs S1, S2, S3, S4, S5, S6 by the evaluation unit 40 takes place in such a way that a change is made recurrently between the first mode and the second mode at least until the heating requirement of the battery 20 is covered and in such a way that an average current flowing through the electric motor 30 corresponds to a direct current which does not induce a torque in the electric motor 30, which is at a standstill. In addition, the control takes place in such a way that respective switching points in time for the recurring change between the first mode and the second mode are determined in dependence on the heating requirement of the battery 20 and in particular are adapted suitably in the course of the heating of the battery 20 by means of a regulation by the evaluation unit 40.

FIG. 2 shows a schematic overview of components of a device according to the invention in connection with a vehicle. The vehicle comprises an inverter 10, a battery 20, which is a drive battery of the vehicle, and an electric motor 30, which is used as a drive motor for the vehicle. The inverter 10, the battery 20, and the electric motor 30 are each thermally coupled with one another by means of a common cooling circuit 60, so that heating of the electric motor 30 and the inverter 10 can be used for heating, in particular preconditioning, of the battery 20. The inverter 10 has an evaluation unit 40, which is coupled in terms of information technology with a charging device 50 of the vehicle by means of a data input 42. In this way, the evaluation unit 40 is configured to receive information about an imminent and/or already running charging process of the battery 20 from the charging device 50. By means of a data output 44, the evaluation unit 40 is electrically connected to respective control inputs of a plurality of SiC-MOSFETs S1, S2, S3, S4, S5, S6 of the inverter 10, via which a DC voltage of the battery 20 is converted in driving operation of the vehicle into an AC voltage in order to operate the electric motor 30 of the vehicle. On the basis of this configuration, the evaluation unit 40 is configured to carry out the above-described method according to the invention, which is implemented here in the form of a computer program executable by the evaluation unit 40.

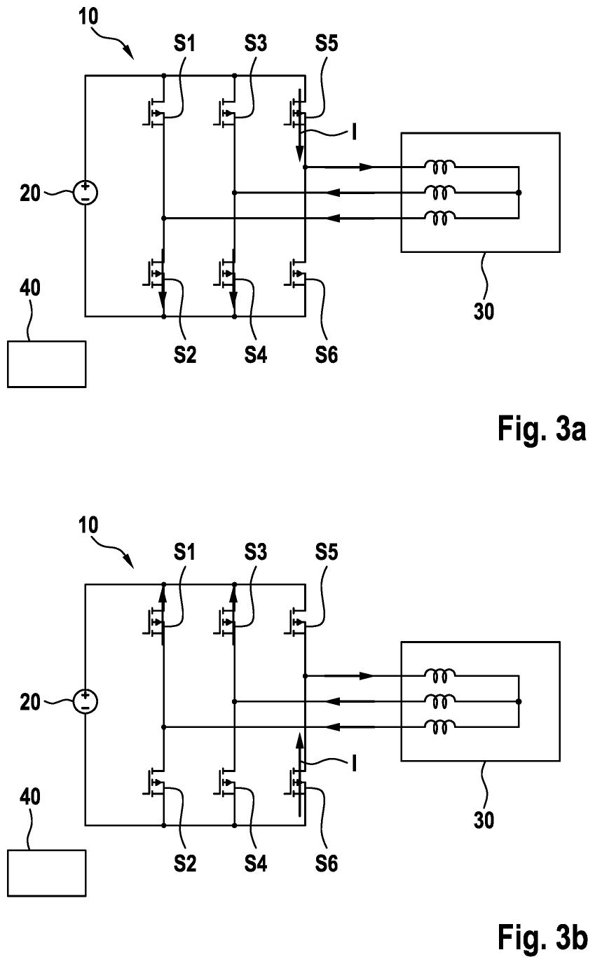

FIG. 3a shows an exemplary control of a three-phase inverter 10 according to the invention according to a first mode. The control is carried out by an evaluation unit 40 according to the invention, which is designed here as a component part of the inverter 10. Respective electrical connections of the evaluation unit 40 to respective gate terminals of SiC-MOSFETs S1, S2, S3, S4, S5, S6 of the inverter 10 are not shown here for reasons of clarity. The control in the first mode, which takes place in accordance with an angular position of a three-phase electric motor 30 at a standstill of the electric motor 30, provides here that the SiC-MOSFETs S1, S3, S6 are in a switched-off state, which is achieved here by a control of gates of these SiC-MOSFETs S1, S3, S6 using a voltage of −5 V. The SiC-MOSFETs S2, S4, S5 are each in a switched-on state, which is achieved here by a control of the gates of these SiC-MOSFETs S2, S4, S5 using a voltage of 18 V. Due to this type of control, in the first mode, a current I provided by a battery 20 flows through SiC-MOSFETs S2, S4, S5 and through the windings of the electric motor 30, as indicated by the arrows. In this case, conduction losses are generated both in the inverter 10 itself and in the windings of the electric motor 30, which can then be used in the form of waste heat for heating the battery 20.

FIG. 3b shows an exemplary control of a three-phase inverter 10 according to the invention according to a second mode. Since FIG. 3b is identical to FIG. 3a with the exception of the control of the SiC-MOSFETs S1, S2, S3, S4, S5, S6 of the inverter 10, only the differences between the figures are described hereinafter to avoid repetitions. The control of the SiC-MOSFETs S1, S2, S3, S4, S5, S6 by the evaluation unit 40 provides in the second mode that the SiC-MOSFETs S1, S3, and S6 remain in the switched-off mode, while the SiC-MOSFETs S2, S4, S5 are now also switched off. A freewheel current generated by the inductances of the electric motor 30 now flows via the inverse diodes of the SiC-MOSFETs S1, S3, S6, by which strong heating of the MOSFETs S1, S3, S6 is generated, which can accordingly be used for heating the battery 20 via the thermal coupling.

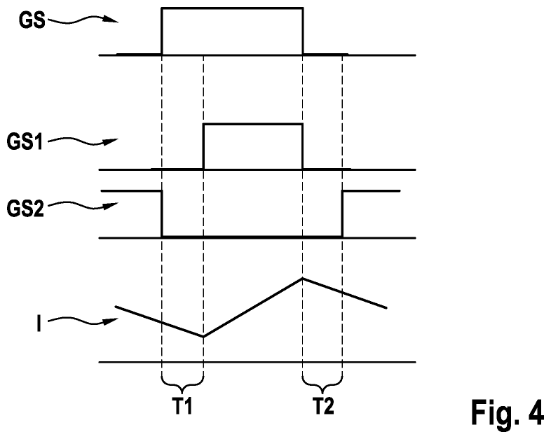

FIG. 4 shows exemplary signal curves of the control of an inverter 10 according to the invention. A signal GS represents a main gating signal for the control of semiconductor switches S1, S2, S3, S4, S5, S6 of the inverter 10, which correspond, for example, with the SiC-MOSFETs S1, S2, S3, S4, S5, S6 in FIGS. 3a and 3b. A signal GS1 derived from the signal GS represents a control signal for a first group of semiconductor switches S1, S2, S3, S4, S5, S6, which are each jointly activated or deactivated as a function of an angular position of a rotor of an electric motor 30 supplied by means of the inverter 10 (for example, the SiC-MOSFETs S2, S4, S5 in FIGS. 3a and 3b). A signal GS2 derived from the signal GS represents a control signal for a second group of semiconductor switches S1, S2, S3, S4, S5, S6, which are each jointly activated or deactivated as a function of the angular position of the rotor of the electric motor 30 (for example, the SiC-MOSFETs S1, S3, S6 in FIGS. 3a and 3b). Moreover, the dead times T1, T2 are shown, which are to be observed during a complementary switching of respective corresponding high-side and low-side semiconductor switches S1, S2, S3, S4, S5, S6 in order to prevent a short circuit within the inverter 10. A current flowing within these dead times T1, T2 via freewheel diodes of specific semiconductor switches S1, S2, S3, S4, S5, S6 generates a high power loss, which can be used as described above for heating a component thermally coupled with the inverter 10, in particular a drive battery 20. An exemplary total current I flowing through the inverter 10 or the electric motor 30, which corresponds on average to a direct current, is shown as signal I in FIG. 4. In the course of carrying out the method according to the invention, it is provided that the signals shown in sections here are recurrently generated until a heating requirement of the thermally coupled component is covered. It is to be noted that parameters (e.g., a duration of the dead time T1 and/or the dead time T2, a repetition frequency, etc.), on the basis of which the respective signals are generated, can advantageously be adapted in the course of carrying out the method according to the invention.

### LIST OF REFERENCE SIGNS

10 inverter
20 battery
30 electric motor
40 evaluation unit
42 data input
44 data output
50 charging device
60 cooling circuit
GS gating signal
GSHS high-side gating signal
GSLS low-side gating signal
I current
S1 first MOSFET
S2 second MOSFET
S3 third MOSFET
S4 fourth MOSFET
S5 fifth MOSFET
S6 sixth MOSFET
T1 first dead time
T2 second dead time

1-10. (canceled)

11. A method for controlling an inverter of a vehicle, the method comprising:
ascertaining information about a heating requirement of a battery of the vehicle which is electrically and thermally coupled with the inverter;
controlling the inverter in a first mode, in which a current provided by the battery flows through an electric motor of the vehicle electrically coupled with an AC terminal of the inverter; and
controlling the inverter in a second mode, which represents a freewheel of the inverter, in which a freewheel current flowing through inverse diodes of semiconductor switches of the inverter results in the heating of the battery thermally coupled with the inverter;
wherein a change is made recurrently between the first mode and the second mode at least until the heating requirement of the battery is covered,
the control of the inverter is carried out in such a way that an average current flowing through the electric motor corresponds to a direct current, which does not induce torque in the electric motor, and
respective switching points in time for a recurring change between the first mode and the second mode are determined in dependence on the heating requirement of the battery.

12. The method according to claim 11, wherein the semiconductor switches of the inverter are SiC-MOSFETs and/or GaN-MOSFETs and/or Si-MOSFETs, and/or
the inverter and the electric motor are each designed as single-phase or multiphase, and/or
the electric motor is an externally excited synchronous machine.

13. The method according to claim 11, wherein the battery is thermally coupled with the electric motor and heating of the electric motor caused by the current flow in the electric motor is additionally used for heating the battery.

14. The method according to claim 12, wherein the battery is thermally coupled with the electric motor and heating of the electric motor caused by the current flow in the electric motor is additionally used for heating the battery.

15. The method according to claim 13, wherein a first heating contribution provided by the inverter and/or a second heating contribution provided by the electric motor for heating the battery are achieved by determining:
switching frequencies of the recurring change between the first mode and the second mode, and/or
levels of respective gate voltages of the semiconductors of the inverter, and/or
durations of dead times which are to be observed during the complementary switching of corresponding high-side and low-side semiconductor switches of the inverter.

16. The method according to claim 14, wherein a first heating contribution provided by the inverter and/or a second heating contribution provided by the electric motor for heating the battery are achieved by determining:
switching frequencies of the recurring change between the first mode and the second mode, and/or
levels of respective gate voltages of the semiconductors of the inverter, and/or
durations of dead times which are to be observed during the complementary switching of corresponding high-side and low-side semiconductor switches of the inverter.

17. The method according to claim 15, wherein the first and second heating contributions are determined in dependence on a current capacity of the inverter and/or the electric motor.

18. The method according to claim 16, wherein the first and second heating contributions are determined in dependence on a current capacity of the inverter and/or the electric motor.

19. The method according to claim 12, wherein the semiconductor switches, the inverse diodes of which conduct the freewheel current in the second mode of the inverter,
are permanently switched off during the entire heating phase or during a part of the heating phase of the battery, and/or
are switched, in consideration of required dead times, in a complementary manner to their respective corresponding high-side or low-side semiconductor switches.

20. The method according to claim 13, wherein the semiconductor switches, the inverse diodes of which conduct the freewheel current in the second mode of the inverter,
are permanently switched off during the entire heating phase or during a part of the heating phase of the battery, and/or
are switched, in consideration of required dead times, in a complementary manner to their respective corresponding high-side or low-side semiconductor switches.

21. The method according to claim 12, wherein required dead times during the complementary switching of corresponding low-side and high-side semiconductor switches are initially determined and/or are adapted over time in dependence on the heating requirement of the battery.

22. The method according to claim 13, wherein required dead times during the complementary switching of corresponding low-side and high-side semiconductor switches are initially determined and/or are adapted over time in dependence on the heating requirement of the battery.

23. The method according to claim 12, wherein
the heating requirement of the battery is ascertained in dependence on a planned charging process of the battery, and/or
heating of the battery corresponding to the heating requirement takes place on the basis of a control and/or a regulation.

24. The method according to claim 13, wherein
the heating requirement of the battery is ascertained in dependence on a planned charging process of the battery, and/or
heating of the battery corresponding to the heating requirement takes place on the basis of a control and/or a regulation.

25. An apparatus for controlling an inverter of a vehicle, the apparatus comprising:
an evaluation unit having a data input and a data output,
wherein the evaluation unit is configured,
in conjunction with the data input, to ascertain information about a heating requirement of a battery of the vehicle electrically and thermally coupled with the inverter,
in conjunction with the data output,
to control the inverter in a first mode, in which a current provided by the battery flows through an electric motor of the vehicle electrically coupled with an AC terminal of the inverter,
to control the inverter in a second mode, which represents a freewheel of the inverter, in which a freewheel current flowing through inverse diodes of semiconductor switches of the inverter results in heating of the battery thermally coupled with the inverter,
to change recurrently between the first mode and the second mode at least until the heating requirement of the battery is covered, and
to control the inverter such that an average current flowing through the electric motor corresponds to a direct current which does not induce torque in the electric motor, and
to determine respective switching points in time for a recurring change between the first mode and the second mode in dependence on the heating requirement of the battery.

26. A vehicle comprising a device according to claim 25.
